(19) United States
(12) Patent Application Publication
(10) Pub. No.: US 2010/0073202 A1
(43) Pub. Date: Mar. 25, 2010

(54) PORTABLE INTERNET APPLIANCE

(76) Inventor: Mohammad A. Mazed, Yorba Linda, CA (US)

Correspondence Address: Haynes and Boone, LLP;IP Section, 2323 Victory Avenue, SUITE 700, Dallas, TX, 75219, US

(21) Appl. No.: 12/238,286

(22) Filed: Sep. 25, 2008

(51) Int. Cl. H04B 14/00

(52) U.S. Cl. 340/999

(57) ABSTRACT

A portable Internet appliance is disclosed herein, that is capable of accessing any content, at any time, from any place and interacting with anything, wherein anything is comprising of one or more of the following: a processor module, a memory module, a sensor module, a radio module, a camera module, a battery module, a biosensor module, a biomarker and an algorithm.

### BACKGROUND OF THE INVENTION

1. Field of Invention

The present invention relates to a portable Internet appliance that is capable of accessing any content, at any time, from any place and interacting with anything.

2. Discussion of the Related Art

More than ever before, users of portable appliances have become more mobile and global. A converged, pervasive, ambient and always-on Internet access can provide a global network of human and appliance interaction and connections, ideas, collaborations, commerce and distributed intelligence. Therefore, a new dimension in connectivity at any time, from any place, to anything is desired.

### SUMMARY

A portable Internet appliance is disclosed herein, that is capable of accessing any content, at any time, from any place and interacting with anything. For our purpose anything may be, for example, one or more of the following: any device with an Internet Protocol (IP) address, a processor module, a memory module, a sensor module, a radio module, a camera module, a battery module, a biosensor module, a biomarker and an algorithm.

The present invention is better understood in the description below with the accompanying drawings.

### BRIEF DESCRIPTION OF THE DRAWINGS

FIG. 1A illustrates an interior back view of the portable Internet appliance 10, according to one embodiment of the present invention.

FIG. 1B illustrates an exterior front view of the portable Internet appliance 10, according to one embodiment of the present invention.

FIG. 1C illustrates an exterior back view of the portable Internet appliance 10, according to one embodiment of the present invention.

FIG. 1D illustrates an interior front view of the portable Internet appliance 10, according to one embodiment of the present invention.

FIG. 2 illustrates a block diagram of a circuit design for constructing the portable Internet appliance 10, according to one embodiment of the present invention.

FIG. 3 illustrates a block diagram of additional components, functionalities and algorithms which can be integrated with the portable Internet appliance 10, according to one embodiment of the present invention.

FIG. 4 illustrates a block diagram of further additional components, functionalities and algorithms which can be integrated with the portable Internet appliance 10, according to one embodiment of the present invention.

FIG. 5 illustrates a block diagram for constructing an object 1020 which can be utilized with the portable Internet appliance 10, according to one embodiment of the present invention.

FIG. 6 illustrates a block diagram of interaction between an object 1020 and the portable Internet appliance 10, along with interactions between the objects 1020 themselves, according to one embodiment of the present invention.

FIG. 7 illustrates a block diagram for constructing a biological object 1160 which can be utilized with the portable Internet appliance 10, according to one embodiment of the present invention.

FIG. 8 illustrates a block diagram of interaction between a biological object 1160 and the portable Internet appliance 10 along with interactions within and between a biological object 1160 and a biological cell 1220, according to one embodiment of the present invention.

### DETAILED DESCRIPTION OF THE PREFERRED EMBODIMENTS

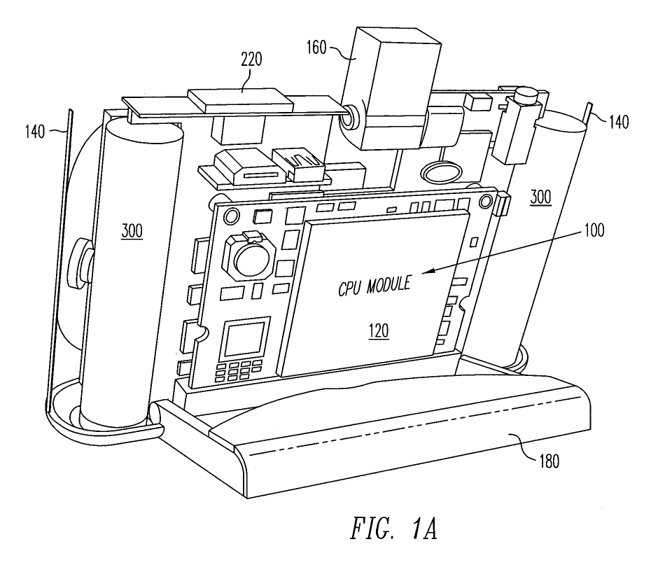

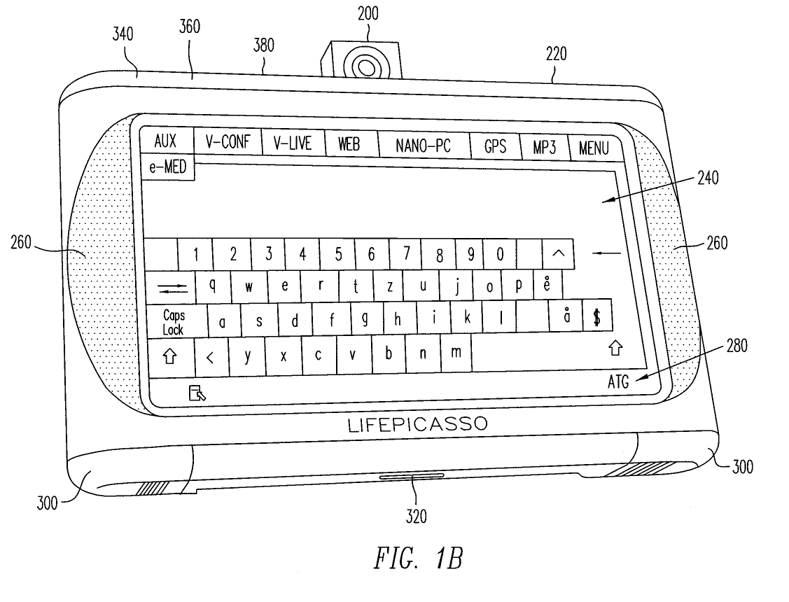

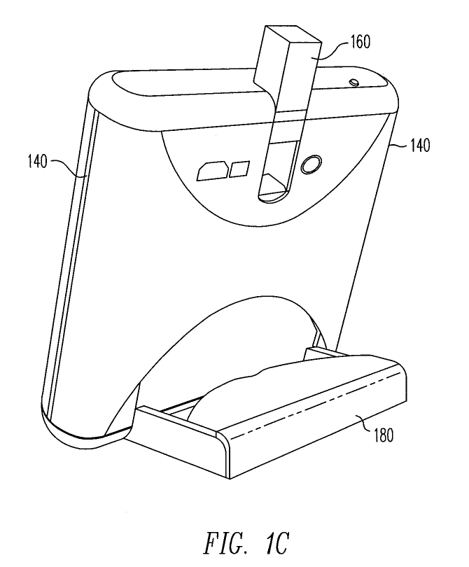

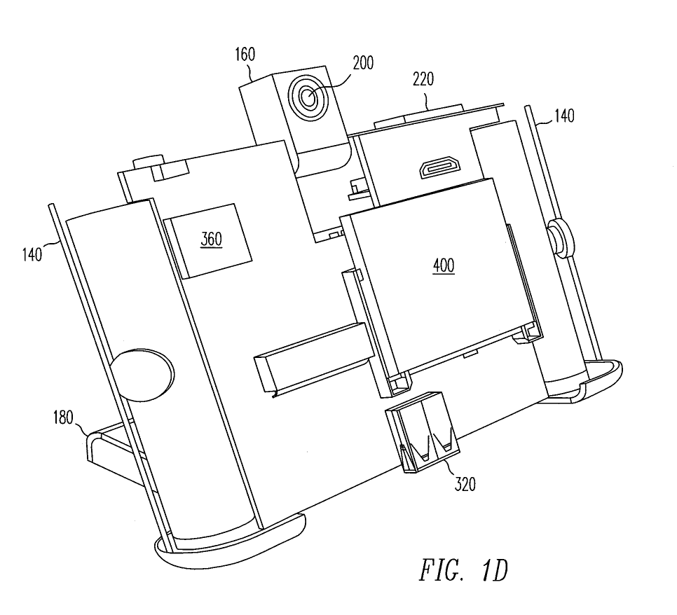

FIG. 1A illustrates an interior back view of the portable Internet appliance 10, according to one embodiment of the present invention. As illustrated in FIG. 1A, the interior of the portable Internet appliance 10 includes (a) an operating system software stored in a system storage (e.g., a NAND Flash) module 100, (b) a processor module 120, (c) a side separator 140, having a first embedded antenna printed onto a package, (d) a rotating camera mount 160, (e) a stand 180, having a second embedded antenna printed thereon, (f) a GPS module 220, having an embedded antenna and (g) a cylindrical battery module 300.

For thermal management, a diamond heat spreader can be attached directly to a processor module 120. Further a copper or an aluminum heat sink can be attached directly to the diamond heat spreader. The heat sink can then be connected to the exterior surface of the package by many metal-filled cylindrical heat-pipes. Thermal resistance and thermal expansion coefficients should be minimized by carefully choosing compatible materials. Furthermore, micro channels could be fabricated by a laser machining method into the diamond heat spreader for liquid cooling.

The materials of the package and the antenna may be carbon fiber embedded plastic and metal respectively, but not limited to the above mentioned materials. Carbon fibers can be inserted into an injection mold of a plastic film and bonded to the molten injected plastic, thereby forming a composite material of carbon fibers and injected molded plastic.

According to one embodiment of the present invention, the size of the portable Internet appliance 10, is approximately 125 mm long, 85 mm wide and 25 mm thick (or deep).

FIG. 1B illustrates an exterior front view of the portable Internet appliance 10. As illustrated in FIG. 1B, the portable Internet appliance includes (a) an auto-focus camera (still-frame and/or a dynamic-frame imaging configuration) module 200, having a flash unit, (b) a GPS module 220, having an embedded antenna, (c) a single-touch-screen or a multi-touch-screen (LCD or organic or laser) display module 240, (d) a speaker module 260, (e) a single-touch-screen or a multi-touch-screen virtual multi-touch-screen keyboard module 280, (f) a cylindrical battery module 300, (g) a USB connection socket 320, (i) a personal area network radio module 340, (e.g., a Wibree module, a Bluetooth module, a WiFi module, an Ultra-Wideband module, a 60 GHz Millimeter-Wave module and/or another Millimeter-Wave module), (j) a wide area network radio module 360, (e.g., a WiMax module) and (g) a communication radio module 380, (e.g., a cellular module and/or a Long Term Evolution (LTE)) module.

FIG. 1C illustrates an exterior back view of the portable Internet appliance 10. As illustrated in FIG. 1C, the portable appliance 10 includes (a) a side separator 140, having a first embedded antenna printed onto a package, (b) a rotating camera mount 160 and (c) a stand 180, having a second embedded antenna printed thereon.

FIG. 1D illustrates an interior front view of the portable Internet appliance 10. As illustrated in FIG. 1D, the portable Internet appliance 10 includes (a) a side separator 140, having a first embedded antenna printed onto a package, (b) a rotating camera mount 160, (c) a stand 180, having a second embedded antenna printed thereon, (d) an auto-focus camera (still-frame and/or a dynamic-frame imaging configuration) module 200, having a flash unit, (e) a GPS module 220, having an embedded antenna, (f) a USB connection socket 320, (g) a wide area network radio module 360, (e.g., a WiMax module) and (h) a fast access upgradeable general data storage module 400.

Any radio module in this detailed description may utilize an embedded antenna or a separate stand-alone antenna.

As illustrated in FIGS. 1A-1D, the portable Internet appliance 10 allows a user to (a) access, create, send, receive, view and store any content (e.g., voice, video, multimedia and data), (b) play games and (c) time-shift (e.g., via remote programming) and place-shift (e.g., via remote Internet storage) any content in a secured manner over IP. However, for video-centric applications (e.g., video conferencing and video TV), significantly higher processing capability, larger transfer bandwidth, specific video format encoding and specific video format decoding are required.

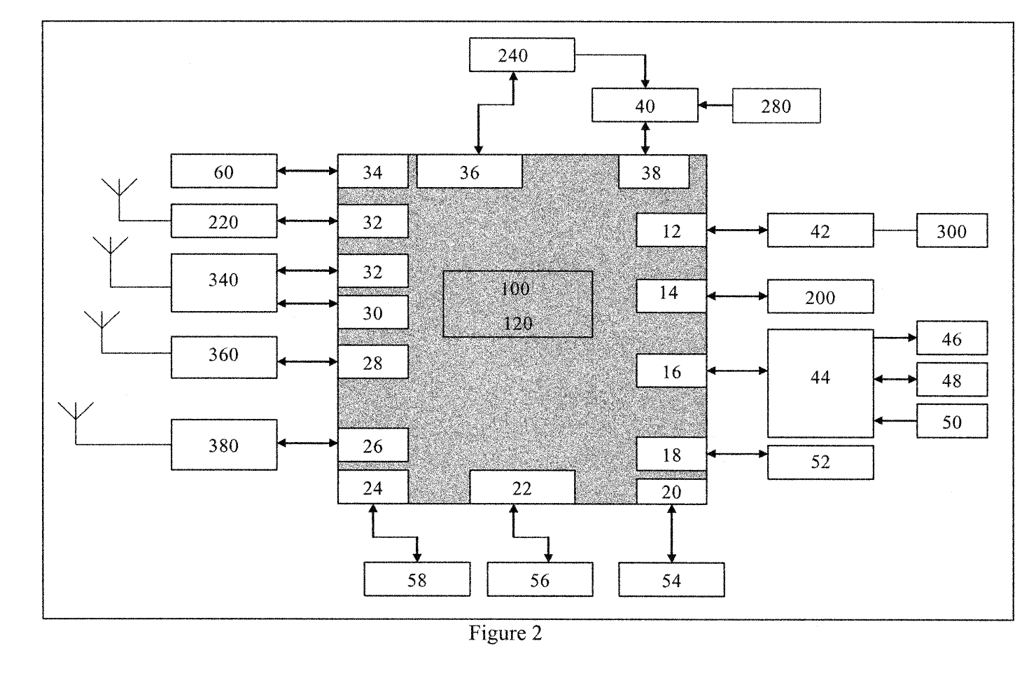

FIG. 2 illustrates a block diagram of a circuit design for constructing the portable Internet appliance 10, according to one embodiment of the present invention. As illustrated in FIG. 2, various electronic and radio modules are controlled and managed by an operating system software stored in a system storage (e.g., a NAND Flash) module 100 and connected to an embedded processor module 120 through interfaces as provided below in Table 1. It is also possible to utilize web-based operating system software. Furthermore, actual configurations and connections to the interfaces can vary depending on the choices of the processor modules, electronic modules and radio modules. The interfaces, key electronic modules and radio modules are summarized below in Table 1:

TABLE 1

| Legend | Description |
|---|---|
| 12 | Power Reset |
| 14 | Camera Controller |
| 16 | McBSP Interface |
| 18 | USB OTG Interface |
| 20 | MS/MMC/SD/SDIO Interface |
| 22 | DDR Controller |
| 24 | Memory Controller |
| 26 | USB Interface |
| 28 | SDIO Interface |
| 30 | SPI Interface |
| 32 | UART Interface |
| 34 | IrDA Interface |
| 36 | Display Controller |
| 38 | I²C Interface |
| 40 | Touch Controller |
| 42 | Power Management Module |
| 44 | Audio Code |
| 46 | Speaker Module |
| 48 | Headphone |
| 50 | MIC |
| 52 | USB Transceiver |
| 54 | Micro SD Slot |
| 56 | Mobile DDR |
| 58 | NAND Flash |
| 60 | FIR Port |
| 100 | Operating System Software In System Storage |
| 120 | Processor Module |
| 200 | Camera Module |
| 220 | GPS Module |
| 240 | Display Module |
| 280 | Virtual Keyboard Module |
| 300 | Battery Module |
| 340 | Wibree Module &/Or Bluetooth Module &/Or WiFi Module |
| 360 | WiMax Module |
| 380 | 3G Module &/Or LTE Module |

As illustrated in FIGS. 1A-1D, the portable Internet appliance 10 of the present invention has multiple radio modules with multiple antennas. These multiple radio modules can be simplified by utilizing a software-defined radio module. Also multiple antennas can be simplified by utilizing a single cavity antenna with a tunable radio-frequency filter. Such a configuration can be utilized to select to a specific radio module with a matching antenna.

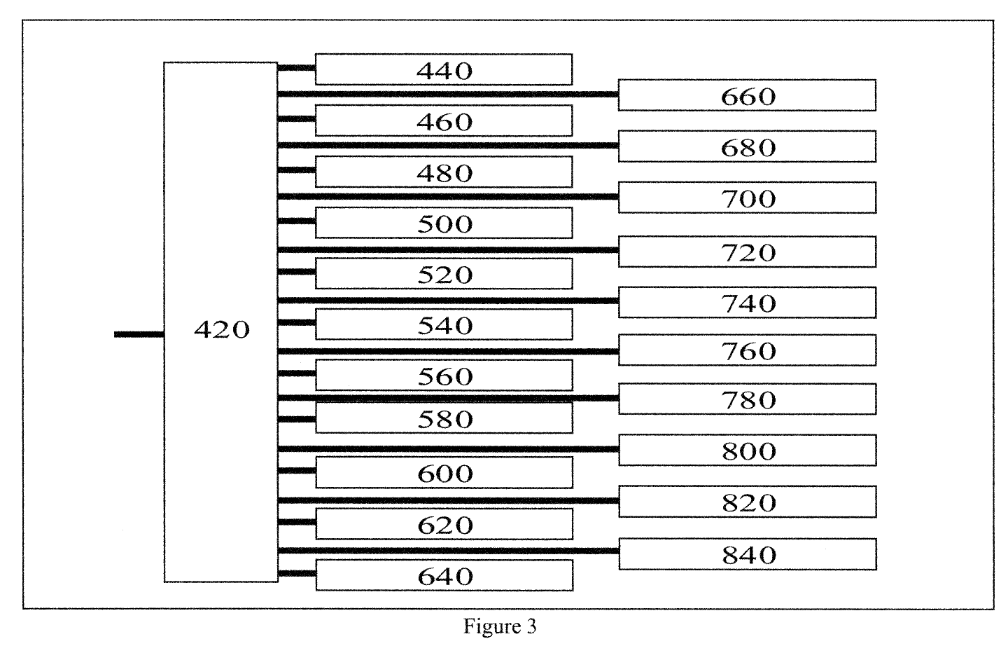

As illustrated in FIG. 3, additional components, functionalities and algorithms can be integrated with the portable Internet appliance 10, according to one embodiment of the present invention. Additional functionalities can be accessed through a network module 420, utilizing one or more IP addresses and IP related algorithms. Furthermore it can include (a) one or more security modules 440, based on the Internet firewall module, a spyware module, a user-specific security control module and a parental control module, an authentication module and related algorithms, (b) one or more diagnostic modules 460, based on an in-situ diagnostic module and a remote (e.g., Internet-enabled) diagnostic module and related algorithms, (c) remote (e.g., Internet-enabled) application software 480, (d) one or more display modules 500, based on a multi-touch-screen display module, a stretchable multi-touch-screen display module and a tiltable multi-touch-screen display module, (e) one or more keyboard modules 520, based on a stretchable multi-touch-screen virtual keyboard module, a radio-enabled keyboard module and an infrared-enabled keyboard module, (f) one or more voice-activated modules 540, based on a voice-to-text and a text-to-voice conversion module and related algorithms, (g) one or more video compression modules 560, based on various compression standards and related algorithms, (h) one or more TV radio modules 580, based on various TV radio standards and related algorithms, (i) one or more general data storage modules 600, based on a magnetic storage module, a holographic storage module, a molecular memory storage module, a 3-D optical module and a remote (e.g., Internet-enabled) storage module, (j) one or more power modules 620, based on a battery module with a built-in integrated fuel cell, a storage capacitor module, a solar cell module, a fuel cell module and a nano-wire enabled battery module, (k) a proximity radio-enabled charger module 640, (l) a software-defined radio module and tunable antenna and related algorithms 660, (m) a projection display module 680, (n) one or more sensor modules 700, based on, a fingerprint sensor module, a retinal scan sensor module, a home sensor module and a medical sensor module and related algorithms, (o) one or more payment transaction modules 720, based on a 2-D barcode scanner, a RFID transceiver and a near-field communication module and related algorithms, (p) one or more content transfer modules 740 for use with a telephone, a set top box, a personal video recorder, a TV, a router, a server and a mobile telephone and related algorithms, (q) one or more time-shift modules and related algorithms 760, (r) one or more place-shift modules and related algorithms 780, (s) one or more voice, video, multi-media, and data-over-IP and related algorithms 800, (t) one or more remote processing modules and related algorithms 820 and (u) one or more intelligence software modules 840, which can include e.g., commercially available behavior modeling software (e.g., software supplied by www.choicestream.com), or any algorithm relating to data mining, data interpretation, pattern recognition, machine vision, fuzzy logic, artificial intelligence, natural language processing, statistical appliance learning, reasoning modeling, behavior modeling, self-learning, interactive learning, software-as-a service and having a software agent and a neural network. The use of behavior modeling and machine learning techniques allow portable Internet appliance 10 to adapt to user preferences, usage patterns and to fine tune algorithms, thereby rendering intelligent behavior in Internet appliance 10.

Some of the algorithms discussed above can consume a significant amount of power due to their computational intensities and computational complexities. Some or all of the algorithms discussed above can be embedded in the portable Internet appliance 10, if their power consumption is feasible without a significant degradation in the user experience. Alternatively, some or all of the algorithms, discussed above can be utilized by securely accessing a remote server and a network of servers.

A user's behavior patterns are stored in a general data storage module 400. A data mining software module and a data interpretation software module can analyze the behavior patterns. A statistical appliance learning software module can learn and relearn the user's behavior patterns. A software agent can search the Internet for new information on particular topics with or without any human input and can recommend any new information to the user.

The portable Internet appliance 10 can provide an electronic sketchpad utilizing a multi-touch-screen monochrome-screen display module or a multi-touch-screen color display module capable of providing high resolution and high contrast ratio, in conjunction with a stylus and hand-writing recognition capabilities and pattern recognition software.

The portable Internet appliance 10 can allow a user to read any RFID tag on a product utilizing a RFID module. As the portable Internet appliance 10 is aware of its location via an embedded GPS module, a user can then search for an availability ranking, a price ranking and a map of distribution locations of the product. Similarly, its RFID module can be utilized to scan information on a bottle of prescription medicine that has a RFID tag, to alert a patient about any potential drug-interactions. Thus, the portable Internet appliance can enable a new business model with a software-as-a-physical search algorithm.

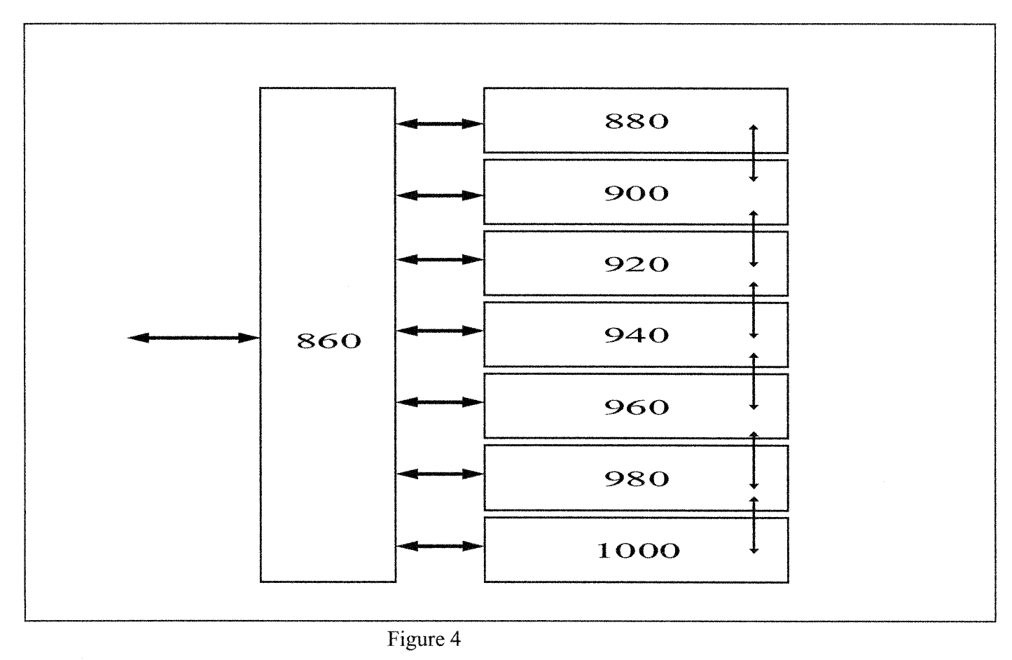

FIG. 4 illustrates further additional components, functionalities and algorithms which can be integrated with the portable Internet appliance 10, according to one embodiment of the present invention. As illustrated in FIG. 4, the portable Internet appliance 10 can be further enhanced in its functionality by incorporating a software module 860, which provides software-as-a-service functionality e.g., a body-implanted biosensor 880 of a user can measure health data (e.g., blood sugar of a user), sends the measured health data to a doctor utilizing a software module 900, a software module 920 can then send the prescription to a pharmacy, a software module 940 can retrieve the location of the pharmacy to which the prescription has been filled-out, a software module 960 can order a transportation service, a software module 980 can calculate a route with the least-traffic and a software module 1000 can enable a secure payment. Thus, portable Internet appliance 10 enables a new business model for accessing various services utilizing a software-as-a-service algorithm.

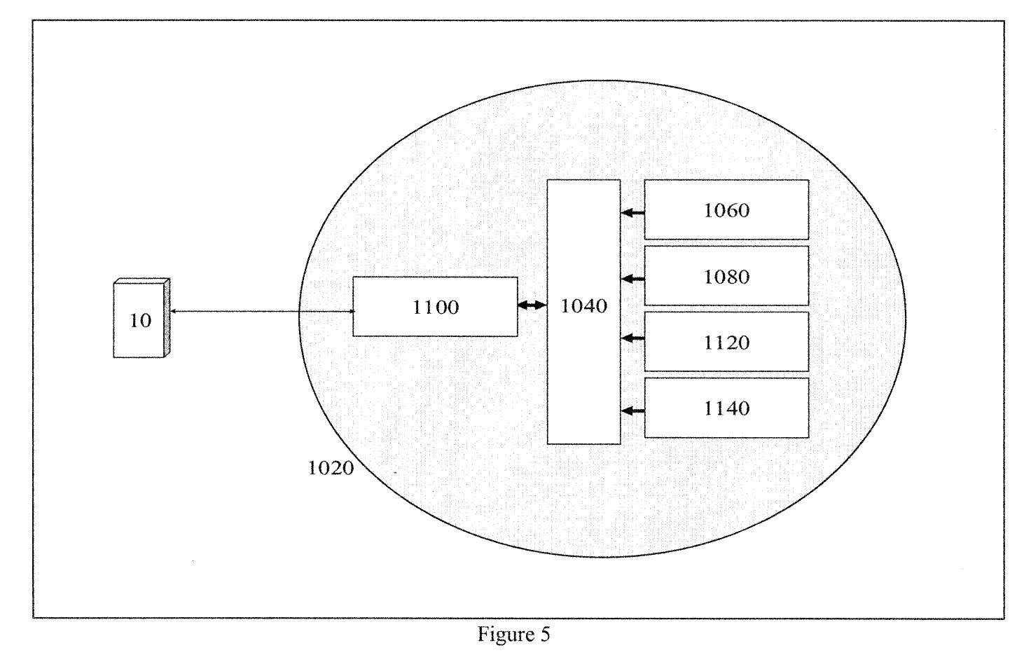

FIG. 5 illustrates a block diagram for constructing an object 1020, having an IP address, a processor module 1040, a memory module 1060, a sensor module 1080, a radio module 1100, (e.g., a communication module or a GPS module or a RFID module), a camera module 1120, a battery module (e.g., a printed battery module) 1140 and related algorithms (e.g., a tiny operating system & a tiny pattern recognition system stored in a memory module 1060) which can interact with the portable Internet appliance 10, according to one embodiment of the present invention. Furthermore, an object 1020 can be constructed utilizing one or more of the following methods: a semiconductor fabrication, a MEMS fabrication, a microfludic fabrication, a printed electronics fabrication, a plastic electronics fabrication, a multi-chip module package of various components and a 3-Dimensional package of various components.

An object 1020, can map, sense, measure, collect, aggregate, compare and share information collected from nearby object(s) 1020. Portable Internet appliance 10 may interact with a large number of objects to obtain information regarding the local environment and may adapt its behavior according to the available resources and sensors provided by the objects in its vicinity.

The portable Internet appliance 10 can act as a node in any radio or sensor network because of its superior processing and power capabilities, than those of objects 1020. Thus it can enable an ambient Internet appliance 10-to-object 1020 communication.

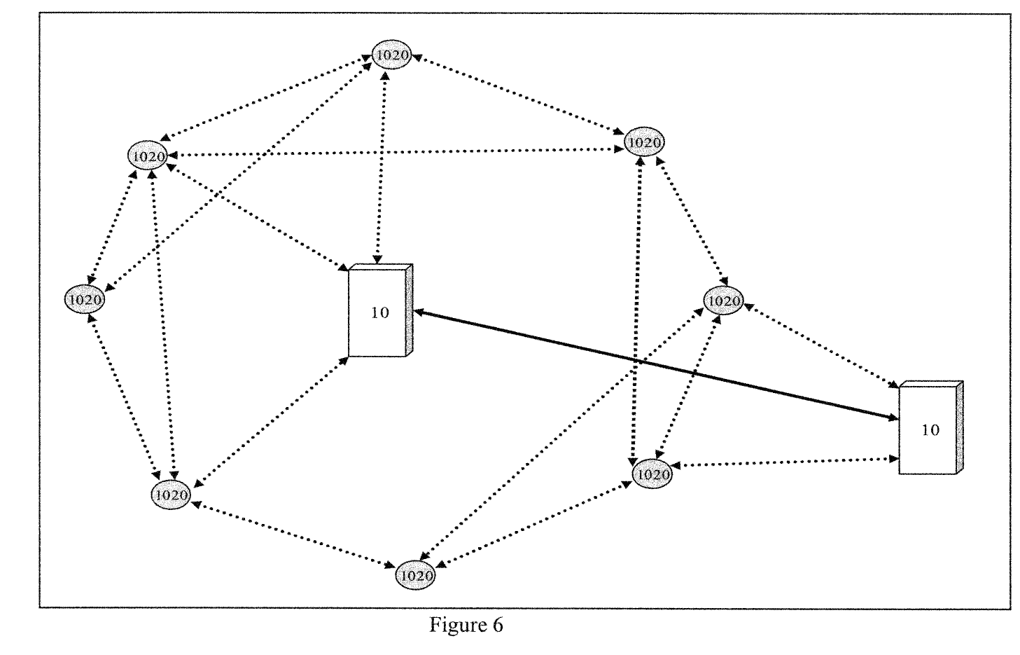

FIG. 6 illustrates a block diagram of interaction between an object 1020 and an Internet appliance 10, along with interactions between the objects 1020 themselves, according to one embodiment of the present invention.

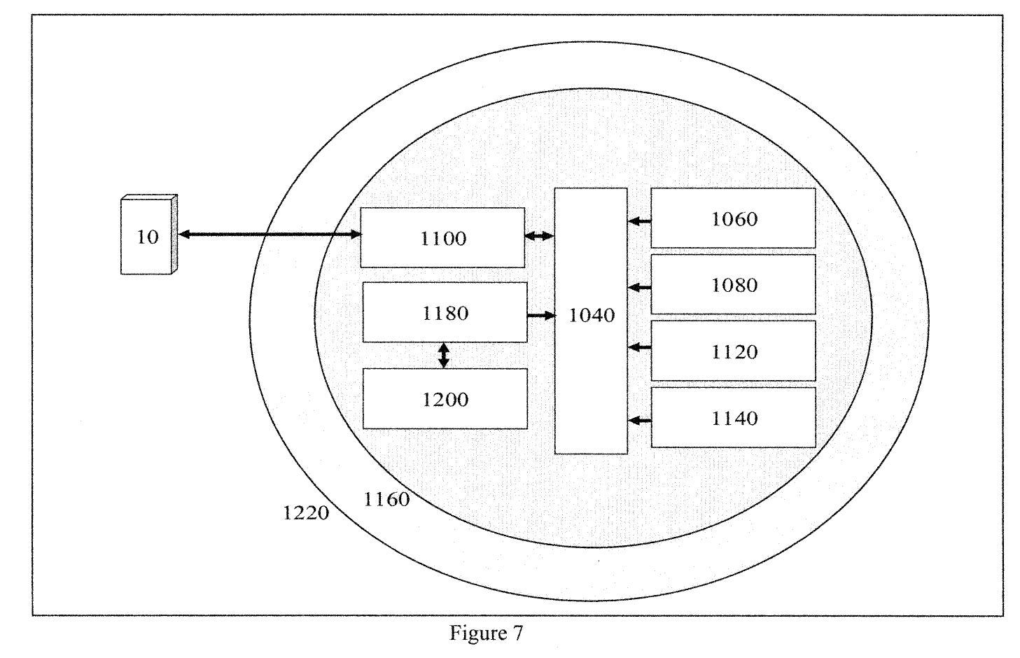

FIG. 7 illustrates a block diagram for constructing a biological object 1160, having an IP address and further comprising a processor module 1040, a memory module 1060, a sensor module 1080, a radio module 1100, a camera module 1120 and a battery module 1140, a biosensor module 1180, a biomarker module 1200 in a compact bio-compatible package and related algorithms which can interact with the portable Internet appliance 10, according to one embodiment of the present invention.

A biosensor 1180 can be constructed utilizing an analyte, a bioreceptor (a molecule recognizing material) and a signal transducer. A biomarker 1200 possesses certain characteristics and properties that can be used as valuable tools in diagnostics. A biological object 1160 is an addition of a biosensor 1180 and a biomarker 1200 to an object 1020.

Furthermore, a biological object 1160 can be constructed utilizing one or more of the following methods: a semiconductor fabrication, a MEMS fabrication, a stereo-lithography fabrication, an injection molding fabrication, a microfludic fabrication, a printed electronics fabrication, a plastic electronics fabrication, a multi-chip module package of various components and a 3-Dimensional package of various components.

A biosensor along with a biomarker can measure a user's heart rhythm and compare the information to a user's nominal rhythm, which is stored in a memory module 1060. If the heart's rhythm is measured or perceived to be abnormal, a processor module 1040 can activate a radio module (e.g., a communication module or a GPS module or a RFID module) with or without any human input for location assisted emergency help

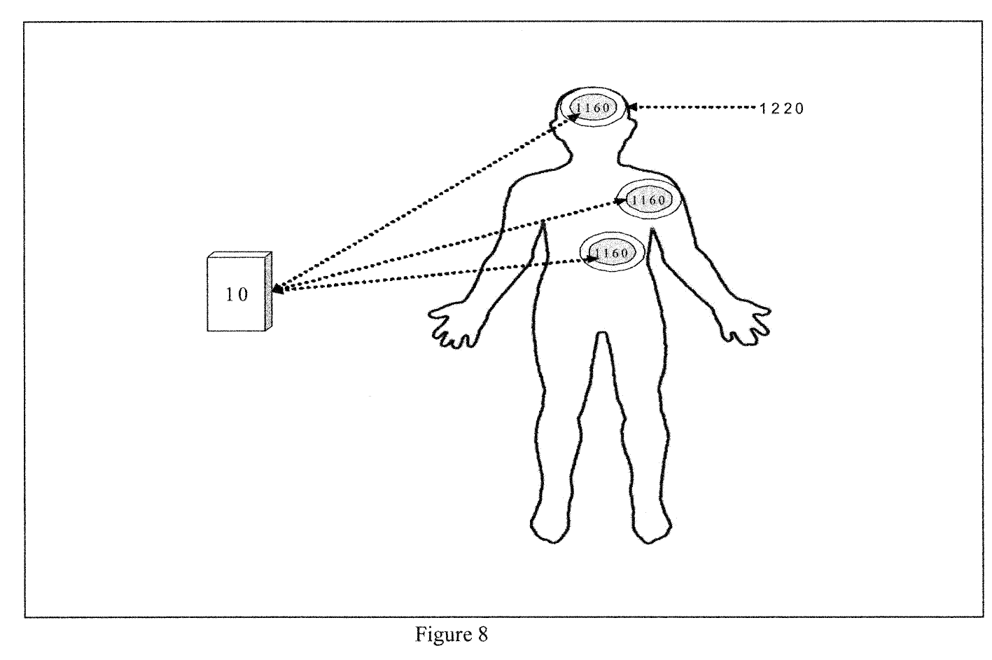

FIG. 8 illustrates a block diagram of interaction between a biological object 1160 and the portable Internet appliance 10 along with interactions within and between a biological object 1160 transmitting a biological cell 1220's images, changes and aging in real time to the portable Internet appliance 10. Such images, changes and aging of a biological cell 1220 in real time can be utilized to monitor diseases.

The above detailed description is provided to illustrate specific embodiments of the present invention and is not intended to be limiting. Numerous variations and modifications within the scope of the present invention are possible. The present invention is set forth in the accompanying claims.

1-52. (canceled)

53. An appliance, comprises:
a processor module;
a system storage module;
a software module selected from the group consisting of the following: an embedded operating system and a web based operating system;
a software module selected from the group consisting of the following: an embedded application and a web based application;
a display module selected from the group consisting of the following: a display, a single-touch-screen display, a multi-touch-screen display, a tiltable display, a stretchable display and a holographic display and a display capable of signal reception from an input module selected from the group consists of the following: human touch, a stylus, a voice, a wire, a radio, a microwave and an infrared;
an input module selected from the group consisting of the following: a microphone, a speaker module, a keyboard module, a stretchable keyboard module, a single-touch-screen virtual keyboard module, a multi-touch-screen virtual keyboard module, a radio enabled keyboard module and an infrared enabled keyboard module;
a data storage module selected from the group consisting of the following: a magnetic storage, a holographic storage, a molecular memory storage, a 3-D optical storage and a remote Internet enabled storage module;
a power supply module selected from the group consisting of the following: a battery module, a battery module with a built-in integrated fuel cell, a storage capacitor module, a solar cell module, a fuel cell module, a nano-wire battery module and a proximity radio-enabled charger module;
a communication module selected from the group consisting of the following: a wired connection, a radio connection, a microwave connection and a sensor based connection, whereas the communication module utilizes a protocol selected from the group consists of the following: a voice-over-IP, a video-over-IP, a multimedia-over-IP and a data-over-IP;
a security module selected from the group consisting of the following: an Internet firewall module, a spyware module, a user specified safety module and a parental control module;
and further utilizes a software module with an algorithm selected from the group consisting of algorithm based on the following: commercial software from www.choicestream.com, data mining, data interpretation, pattern recognition, machine vision, fuzzy logic, artificial intelligence, natural language processing, statistical appliance learning, reasoning modeling, behavior modeling, self-learning, interactive learning, software-as-a service, software-as-a-physical search and having a software agent and a neural network.

54. An appliance as in claim 53, wherein the appliance further comprises the following: an efficient thermal interface material and a heat spreader.

55. An appliance as in claim 53, wherein the appliance further comprises a heat sink.

56. An appliance as in claim 53, wherein the appliance further comprises active air cooling.

57. An appliance as in claim 53, wherein the appliance further comprises active liquid cooling.

58. An appliance as in claim 53, wherein the appliance further comprises a package material constructed from carbon fiber and plastic.

59. An appliance as in claim 53, wherein the appliance further comprises an antenna printed onto a package.

60. An appliance as in claim 53, wherein the appliance further comprises an antenna printed onto a stand.

61. An appliance as in claim 53, wherein the appliance further comprises a content-capture module selected from the group consisting of the following: a fixed focus still-frame camera, a rotating fixed focus still-frame camera, an auto focus still-frame camera, a rotating auto focus still-frame camera and a flash unit.

62. An appliance as in claim 53, wherein the appliance further comprises a content-capture module selected from the group consisting of the following: a fixed focus dynamic-frame camera, a rotating fixed focus dynamic-frame camera, an auto focus dynamic-frame camera, a rotating auto focus dynamic-frame camera and a flash unit.

63. An appliance as in claim 53, wherein the appliance further comprises a projection display module.

64. An appliance as in claim 53, wherein the appliance further comprises a module selected from the group consisting of the following: a video compression module, a voice-to-text conversion module and a text-to-voice conversion module.

65. An appliance as in claim 53, wherein the appliance further comprises an algorithm for a module selected from the group consisting of the following: a video compression algorithm, a voice-to-text conversion algorithm and a text-to-voice conversion algorithm.

66. An appliance as in claim 53, wherein the appliance further comprises a personal area network radio module selected from the group consisting of the following: a Wibree module, a Bluetooth module, a WiFi module, an Ultra-Wideband module, a 60 GHz Millimeter-Wave module and other Millimeter-Wave modules.

67. An appliance as in claim 53, wherein the appliance further comprises an algorithm for a personal area network radio module selected from the group consisting of the following: a Wibree module, a Bluetooth module, a WiFi module, an Ultra-Wideband module, a 60 GHz Millimeter-Wave module and other Millimeter-Wave modules.

68. An appliance as in claim 53, wherein the appliance further comprises a wide area network area radio module compatible with WiMax.

69. An appliance as in claim 53, wherein the appliance further comprises an algorithm for a wide area network radio module compatible with WiMax.

70. An appliance as in claim 53, wherein the appliance further comprises a communication radio module selected from the group consisting of the following: Cellular module and a LTE module.

71. An appliance as in claim 53, wherein the appliance further comprises an algorithm for a communication radio module selected from the group consisting of the following: Cellular module and a LTE module.

72. An appliance as in claim 53, wherein the appliance further comprises a TV radio module.

73. An appliance as in claim 53, wherein the appliance further comprises an algorithm for a TV radio module.

74. An appliance as in claim 53, wherein the appliance further comprises a module for a fixed-to-mobile-to-fixed conversion, the target of the conversion being selected from the group consisting of the following: a phone, a computer, a set top box, a personal video recorder, a holographic display, a TV, a router, a server, a mobile phone and a remote Internet enabled storage module.

75. An appliance as in claim 53, wherein the appliance further comprises an algorithm for a fixed-to-mobile-to-fixed conversion, the target of the conversion being selected from the group consisting of the following: a phone, a computer, a set top box, a personal video recorder, a holographic display, a TV, a router, a server, a mobile phone and a remote Internet enabled storage module.

76. An appliance as in claim 53, wherein the appliance further comprises a module selected from the group consisting of the following: a GPS module, a 2-D Barcode scanner, a RFID module, a near-field communication module and a security sensor module.

77. An appliance as in claim 53, wherein the appliance further comprises an algorithm for a module selected from the group consisting of the following: of a GPS module, a 2-D Barcode scanner, a RFID module, a near-field communication module and a security sensor module.

78. An appliance as in claim 53, wherein the appliance further comprises a module selected from the group consisting of the following: a time-shift module and a place-shift module for any content.

79. An appliance, as in claim 53, wherein the appliance further comprises an algorithm for a module selected from the group consisting of the following: a time-shift module and a place-shift module for any content.

80. An appliance as in claim 53, wherein the appliance further comprises a module selected from the group consisting of the following: a software-defined radio and a tunable antenna.

81. An appliance as in claim 53, wherein the appliance further comprises an algorithm for a module selected from the group consisting of the following: a software-defined radio and a tunable antenna.

82. An appliance as in claim 53, wherein the appliance further comprises a diagnostic module selected from the group consisting of the following: an in-situ diagnostic module and a remote control diagnostic module.

83. An appliance as in claim 53, wherein the appliance further comprises a module selected from the group consisting of the following: a security sensor module, a home sensor module and a medical sensor module.

84. An appliance as in claim 53, wherein the appliance further comprises an algorithm for a module selected from the group consisting of the following: a security sensor module, a home sensor module and a medical sensor module.

85. An appliance as in claim 53, wherein the appliance further communicates with module selected from the group consisting of the following: a security sensor module, a home sensor module and a medical sensor module.

86. An appliance as in claim 53, wherein the appliance further utilizes voice recognition software.

87. An appliance as in claim 53, wherein the appliance further utilizes hand-writing recognition software.

88. An appliance as in claim 53, wherein the appliance further utilizes pattern recognition software.

89. An appliance as in claim 53, wherein the appliance further utilizes voice-over-IP.

90. An appliance as in claim 53, wherein the appliance further utilizes video-over-IP.

91. An appliance as in claim 53, wherein the appliance further utilizes multimedia-over-IP.

92. An appliance as in claim 53, wherein the appliance further utilizes data-over-IP.

93. An appliance as in claim 53, wherein the appliance further utilizes remote computing.

94. An appliance as in claim 53, wherein the appliance further employs a business model with a software-as-a-physical search algorithm.

95. An appliance as in claim 53, wherein the appliance further employs a business model with a software-as-a-service algorithm.

96. An appliance as in claim 53, wherein the appliance further utilizes self-learning.

97. An appliance as in claim 53, wherein the appliance further utilizes appliance to appliance communication.

98. An appliance as in claim 53, wherein the appliance further utilizes appliance to object communication.

99. An appliance as in claim 53, wherein the appliance further utilizes appliance to biological object communication.

100. An appliance as in claim 53, wherein the appliance further utilizes one or more of the following connectivity types: a wire, a radio, a microwave and a sensor.

101. An object comprises one or more components selected from the group consisting of the following: a communication interface associated with an IP address, a processor module, a memory module, a sensor module, a radio module, a camera module, a battery module, a package and algorithm, wherein the object's construction methods selected from the group consists of the following: a semiconductor fabrication, a MEMS fabrication, a microfluidic fabrication, a printed electronics fabrication, a plastic electronics fabrication, an electronic packaging, a multi-chip module packaging and a 3-Dimensional packaging.

102. An object as in claim 101, wherein the object further utilizes an interactive algorithm with other objects.

103. An object as in claim 101, wherein the object further utilizes a distributive algorithm with other objects.

104. An object as in claim 101, wherein the object further utilizes one or more of the following connectivity types: a wire, a radio, a microwave and a sensor.

105. A biological object comprises one or more components selected from the group consisting of the following: a communication interface associated with an IP address, a processor module, a memory module, a sensor module, a radio module, a camera module, a battery module, a biosensor module, a biomarker module, a bio-compatible package and algorithm, wherein the biological object's construction methods selected from the group consists of the following: a semiconductor fabrication, a MEMS fabrication, a stereo-lithography fabrication, an injection molding fabrication, a microfluidic fabrication, a printed electronics fabrication, a plastic electronics fabrication, a bio-compatible packaging, a bio-compatible multi-chip module packaging and a bio-compatible 3-Dimensional packaging.

106. A biological object as in claim 105, wherein the biological object further utilizes one or more of the following connectivity types: a wire, a radio, a microwave and a sensor.

107. An apparatus to monitor biological processes and images near or within a biological object, wherein the biological object comprises one or more components selected from the group consisting of the following: a communication interface associated with an IP address, a processor module, a memory module, a sensor module, a radio module, a camera module, a battery module, a biosensor module, a biomarker module and a bio-compatible package.

108. A method to monitor biological processes and images near or within a biological object, wherein the biological object comprises one or more components selected from the group consisting of the following: a communication interface associated with an IP address, a processor module, a memory module, a sensor module, a radio module, a camera module, a battery module, a biosensor module, a biomarker module and an algorithm.

109. An appliance comprises one or more components selected from the group consisting of the following: a composite package material of carbon fiber and plastic, a stretchable display, a stretchable keyboard, a battery module with a built-in integrated fuel cell and a nano-wire battery module.

110. An appliance as in claim 109, wherein the appliance further utilizes a software module with an algorithm selected from the group consisting of the following: commercial software from www.choicestream.com, data mining, data interpretation, pattern recognition, machine vision, fuzzy logic, artificial intelligence, natural language processing, statistical appliance learning, reasoning modeling, behavior modeling, self-learning, interactive learning, software-as-a service, software-as-a-physical search and having a software agent and a neural network.

111. An appliance as in claim 109, wherein the appliance further utilizes appliance to object communication, wherein the object comprises one or more components selected from the group consisting of the following: a communication interface associated with an IP address, a processor module, a memory module, a sensor module, a radio module, a camera module, a battery module, a package and algorithm, wherein the object's construction methods selected from the group consists of the following: a semiconductor fabrication, a MEMS fabrication, a microfluidic fabrication, a printed electronics fabrication, a plastic electronics fabrication, an electronic packaging, a multi-chip module packaging and a 3-Dimensional packaging.

112. An appliance as in claim 109, wherein the appliance further utilizes appliance to biological object communication, wherein the biological object comprises one or more components selected from the group consisting of the following: a communication interface associated with an IP address, a processor module, a memory module, a sensor module, a radio module, a camera module, a battery module, a biosensor module, a biomarker module, a bio-compatible package and algorithm, wherein the biological object's construction methods selected from the group consists of the following: a semiconductor fabrication, a MEMS fabrication, a stereo-lithography fabrication, an injection molding fabrication, a microfluidic fabrication, a printed electronics fabrication, a plastic electronics fabrication, a bio-compatible packaging, a bio-compatible multi-chip module packaging and a bio-compatible 3-Dimensional packaging.
